(19) United States
(12) Patent Application Publication
(10) Pub. No.: US 2019/0145504 A1
(43) Pub. Date: May 16, 2019

(54) LINEAR SERIES ELASTIC ACTUATOR

(71) Applicant: NATIONAL CHENG KUNG UNIVERSITY, Tainan City (TW)

(72) Inventor: Chao-Chieh Lan, TAINAN CITY (TW)

(21) Appl. No.: 15/815,539

(22) Filed: Nov. 16, 2017

(51) Int. Cl. F16H 25/20; G01L 1/04

(52) U.S. Cl. CPC F16H 25/2015; B25J 9/0006; Y10S 901/24; G01L 1/042

(57) ABSTRACT

An actuator has a linear driving mechanism, an output member, and an elastic member. The linear driving mechanism has a stepping motor, a thread rod assembly, and a linearly moveable member. The threaded rod assembly is connected with the stepping motor. The linearly moveable member is located at a side of the stepping motor and is connected with and driven by the thread rod assembly to reciprocatively move along a power input axis. The output member is disposed on a side of the linearly moveable member and has a capability of linearly moving along a power output axis that is co-axial with the power input axis. The elastic member is connected between the linearly moveable member and the output member to provide an elastic force along the power input axis.

### BACKGROUND OF THE INVENTION

### 1. Field of the Invention

The present invention relates to an actuator, and more particularly to a linear series elastic actuator in series connection that can be applied to a humanoid robot or a rehabilitation robot.

### 2. Description of Related Art

A conventional industrial robot is applied with a motor module to serve as a driving device. Because the industrial robots need speed and rigidity in operation, the industrial robot needs a driving device having a large volume. However, for rehabilitation robots, humanoid robots or prosthetic robots, the driving devices for these robots are designed to have light weight so that high torque density motors are used in these robots.

However, the conventional motor modules for rehabilitation robots are designed as those for industrial robots and mainly use brushed motors or brushless motors and have insufficient torque density. Therefore, the conventional motor modules are not applied as the driving devices for rehabilitation robots, humanoid robots or prosthetic robots. In addition, the motor module of a conventional driving device uses a belt wheel assembly or gear assembly to transmit the power to an output axle, such that the loss of the transmission of the motor torque is increased.

To overcome the shortcomings, the present invention tends to provide a linear series elastic actuator to mitigate or obviate the aforementioned problems.

### SUMMARY OF THE INVENTION

The main objective of the invention is to provide a linear series elastic actuator to provide a sufficient torque density and to prevent loss of torque transmission.

The actuator has a linear driving mechanism, an output member, and an elastic member. The linear driving mechanism has a stepping motor, a thread rod assembly, and a linearly moveable member. The threaded rod assembly is connected with the stepping motor. The linearly moveable member is located at a side of the stepping motor and is connected with and driven by the thread rod assembly to reciprocatively move along a power input axis. The output member is disposed on a side of the linearly moveable member and has a capability of linearly moving along a power output axis that is co-axial with the power input axis. The elastic member is connected between the linearly moveable member and the output member to provide an elastic force along the power input axis.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a linear series elastic actuator in accordance with the present invention;

FIG. 2 is another perspective view of the actuator in FIG. 1;

FIG. 3 is a top view of the actuator in FIG. 1;

FIG. 4 is a perspective view of a second embodiment of a linear series elastic actuator in accordance with the present invention;

FIG. 5 is another perspective view of the actuator in FIG. 4; and

FIG. 6 is a top view of the actuator in FIG. 4.

### DETAILED DESCRIPTION OF PREFERRED EMBODIMENT

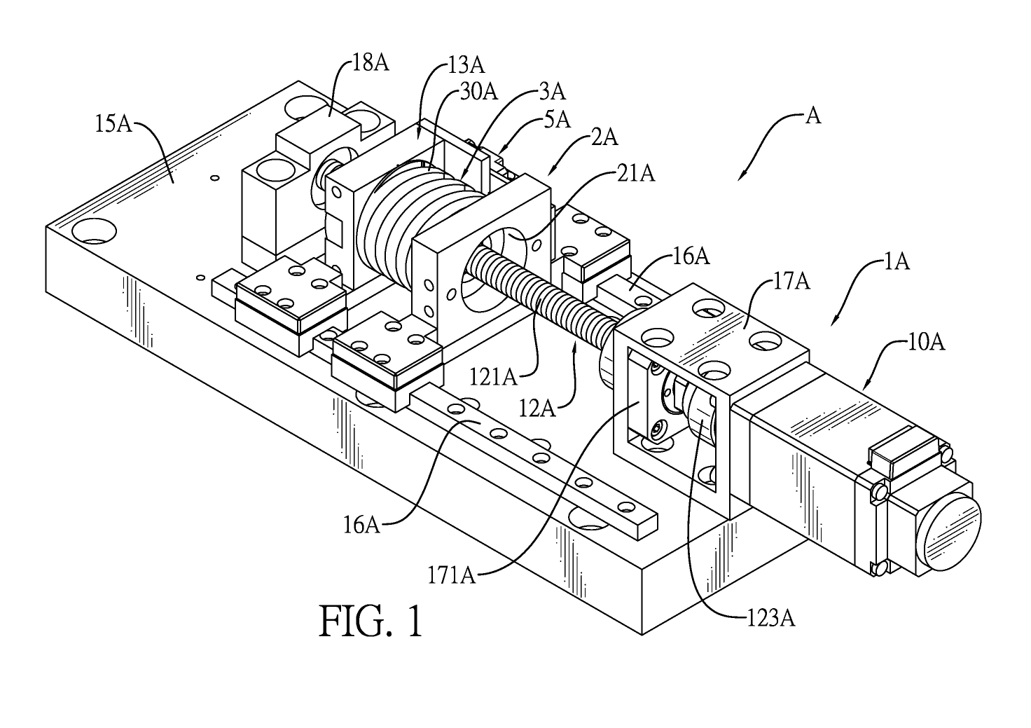

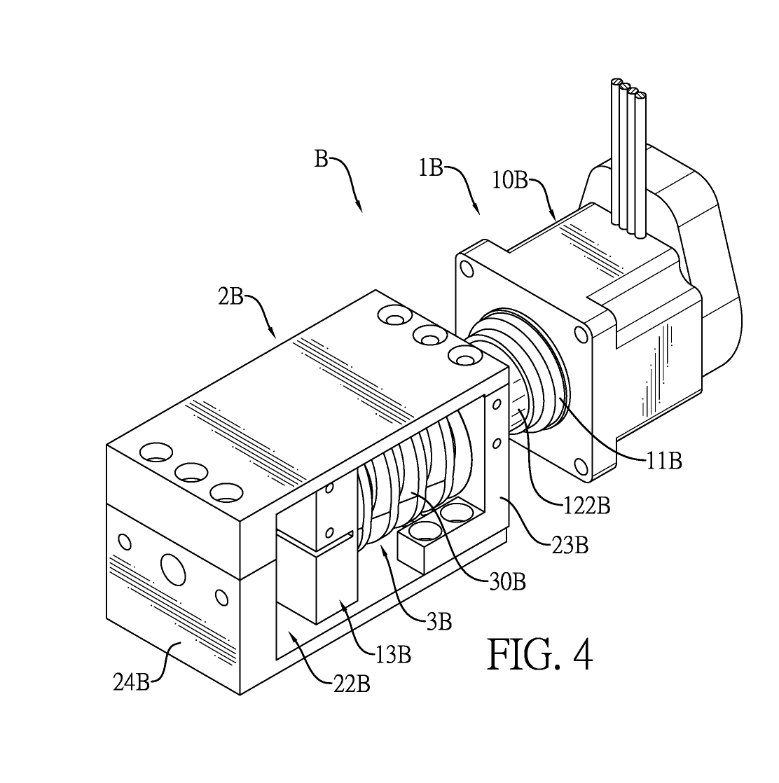

With reference to FIGS. 1 and 4, an actuator A, B in accordance with the present invention comprises a linear driving mechanism 1A, 1B, an output member 2A, 2B, and an elastic member 3A, 3B.

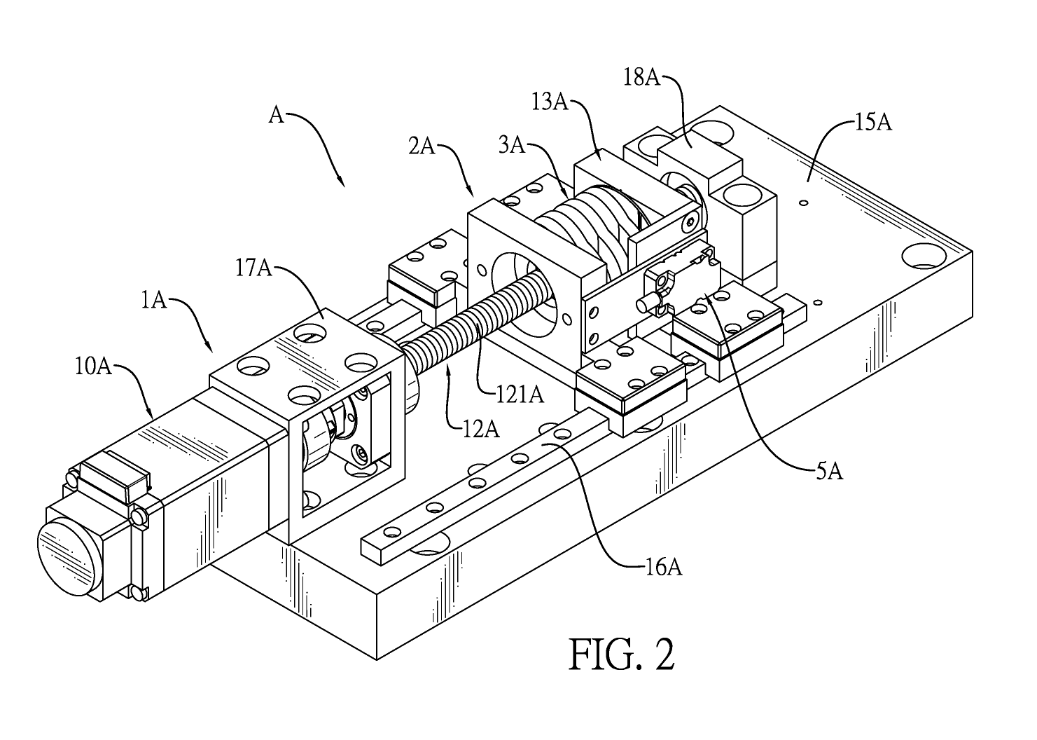

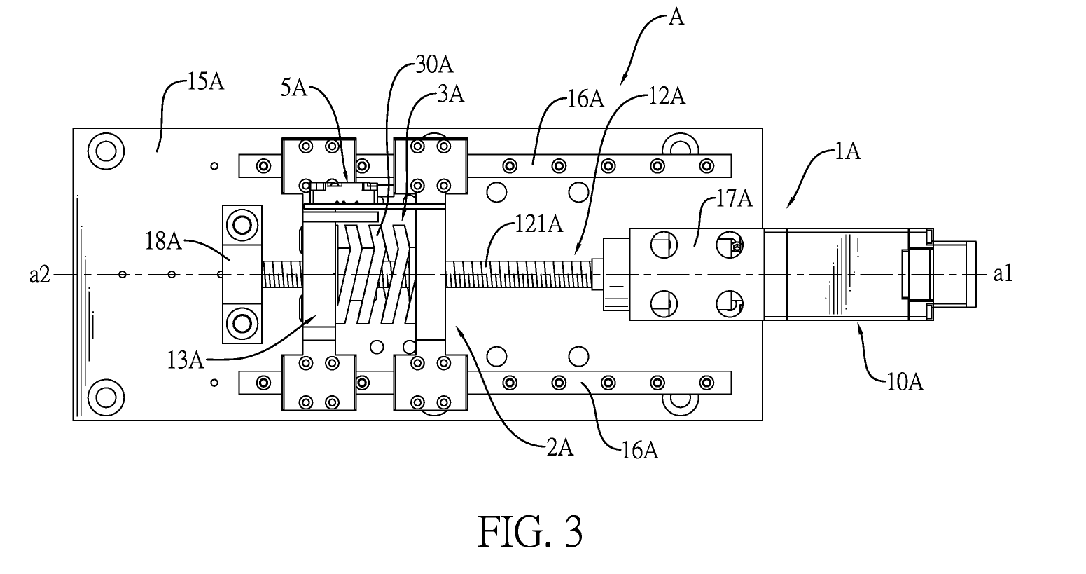

With reference to FIGS. 1 to 4, the linear driving mechanism 1A, 1B comprises a stepping motor 10A, 10B, a threaded rod assembly 12A, 12B, and a linearly moveable member 13A, 13B. The threaded rod assembly 12A, 12B is connected with the stepping motor 10A, 10B. The linearly moveable member 13A, 13B is located at a side of the stepping motor 10A, 10B and is connected with and driven by the thread rod assembly 12A, 12B to reciprocatively move along a power input axis a1.

The output member 2A, 2B is disposed on a side of the linearly moveable member 13A, 13B and can linearly move along a power output axis a2 that is co-axial with the power input axis a1.

The elastic member 3A, 3B is connected between the linearly moveable member 13A, 13B and the output member 2A, 2B to provide an elastic force along the power input axis a2.

With reference to FIGS. 1 to 3, in the first embodiment, the stepping motor 10A has a driving axle, and the output member 2A is disposed between the linearly moveable member 13A and the stepping motor 10A and has a through hole 21A. The threaded rod assembly 12A comprises a threaded rod 121A and a sleeve. The threaded rod 121A is co-axially connected with the driving axle of the rotator of the stepping motor 10A by a connector 123A and extends through the through hole 21A in the output member 2A along the power input axis a1. The end of the threaded rod 121A that is distal from the stepping motor 10A is mounted rotatably in a supporting base 18A. A supporting frame 17A is mounted around the connector 123A, and the stepping motor 10A is mounted securely on the supporting frame 17A. A bearing base 171A is mounted in the supporting frame 17A, and the end of the threaded rod 121A that is adjacent to the stepping motor 10A is mounted rotatably in the bearing base 171A. The sleeve is mounted in the linearly moveable member 13A and is mounted around the threaded rod 121A.

The actuator A may further comprise at least one rail 16A. Preferably, two rails 16A are implemented. The rails 16A are parallel with the threaded rod 121A. The linearly moveable member 13A and the output member 2A are mounted on the rails 16A and are moveable along the rails 16A. In addition, the actuator A may further comprise a bottom base 15A. The stepping motor 10A is mounted securely on the bottom base 15A by the supporting frame 17A, and the rails 16A are mounted securely on the bottom base 15A.

The elastic member 3A comprises a spring 30A mounted around the threaded rod 121A and has two ends abutting respectively on the linearly moveable member 13A and the output member 2A.

In addition, the actuator A may further comprise a displacement sensor 5A mounted on one side of the elastic member 3A to detect a deformation of the elastic member 3A and to calculate an output force. Accordingly, the output force provided by the actuator A can be precisely controlled.

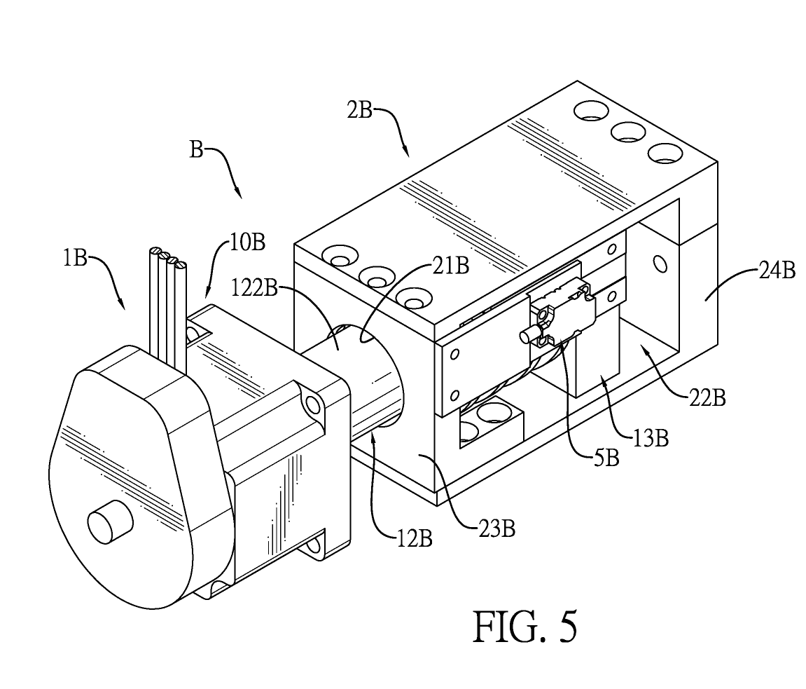

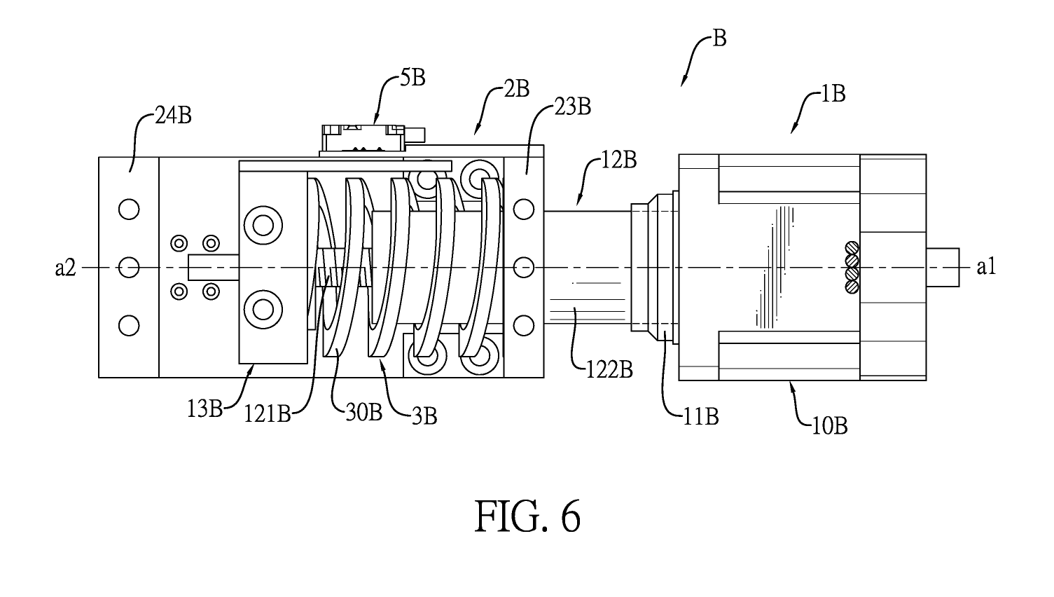

With reference to FIGS. 4 to 6, in the second embodiment, the stepping motor 10B has a rotator 11B having an axial hole defined through the rotator 11B. The linearly movable member 13B is mounted in the output member 2B. The threaded rod assembly 12B comprises a threaded rod 121B and a sleeve 122B mounted around the threaded rod 121B. The threaded rod 121B is co-axially connected with the rotator 11B and extends into the output member 2B along the power input axis a1. The threaded rod 121B has a distal end connected with the linearly moveable member 13B. The elastic member 3B comprises a spring 30B mounted around the threaded rod assembly 12B and has two ends abutting respectively on the linearly moveable member 13B and the output member 2B.

Furthermore, the output member 2B has a movement space 22B, a first side board 23B, and a second side board 24B. The movement space 22B is defined in the output member 2B. The first side board 23B and the second side board 24B are disposed respectively at two opposite sides of the movement space 22B. The first side board 23B has a through hole 21B defined through the first side board 23B and communicating with the movement space 22B. The linearly moveable member 13B is mounted linearly moveably in the movement space 22B of the output member 2B. The sleeve 122B is connected securely with one end of the rotator 11B. The threaded rod 121B is linearly moveably mounted through the rotator 11B, the sleeve 122B, the through hole 21B in the first side board 23B and extends into the movement space 22B. The spring 30B is mounted around the threaded rod 121B, and the two ends of the spring 30B abut respectively on the linearly moveable member 13B and the first side board 23B.

In the second embodiment, a displacement sensor 5B is mounted on one side of the elastic member 3B to detect a deformation of the elastic member 3B and to calculate an output force.

The linear series elastic actuator A, B in accordance with the present invention can be applied in rehabilitation robots, humanoid robots, prosthetic robots or interactive robots and is connected with the moveable components of the robots to provide power to the robots.

With reference to FIGS. 1 to 3, with such an arrangement, the stepping motor 10A serves as the power source for the linear driving mechanism 13A and has a driving effect in dual directions, clockwise and counterclockwise. The stepping motor 10A can provide a torque to drive the linearly moveable member 13A to move linearly with the transmission of the threaded rod assembly 12A, and the output member 2A that is connected with a load is driven to linearly move by the elastic member 3A. Consequently, a robot can be operated. With a small rigidity of the elastic member 3A mounted between the output member 2A and the linearly moveable member 13A, the output force provided by the stepping motor 10A can be precisely controlled in the range of the deformation of the elastic member 3A.

In addition, with the displacement sensor 5A mounted on a side of the elastic member 3A, the deformation of the elastic member 3A can be detected and the output force can be calculated. Accordingly, the output force in the dual directions can be precisely controlled by the displacement sensor 5A at a low cost, and the advantages of high torque density and precise control in force can be achieved.

The stepping motor 10A, 10B has the advantages of dual directional driving effect, high torque density, low in cost, and high reliability. With the low rigidity of the elastic member 3A, 3B between the linearly moveable member 13A, 13B and the output member 2A, 2B, the output force provided by the stepping motor 10A, 10B can be precisely controlled in the range of the deformation of the elastic member 3A, 3B. The linear series elastic actuator A has an excellent utility.

Furthermore, the actuator in accordance with the present invention A, B has a structure in series connection and the co-axial input and output axes a1, a2, so the structure of the linear series elastic actuator A, B is compact, simplified, reduced in volume, and light in weight. The stepping motor 10A, 10B can drive the threaded rod 121A, 121B directly and provide an output force via the co-axial linearly movable member 13A, 13B and the output member 2A, 2B to linearly move the output member 2A, 2B, such that the loss of the torque transmission of the stepping motor 10A, 10B can be effectively reduced. In addition, the elastic member 3A, 3B co-axially connects the linearly moveable member 13A, 13B with the output member 2A, 2B and can transmit force in dual directions to provide functions of energy-storing and buffering. The linear series elastic actuator A, B can be applied in rehabilitation robots, humanoid robots or prosthetic robots that need mobility, affinity between humans and the machine, and interaction between humans and the machine, and provide power sources to these robots to ensure the safety of using these robots.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A linear series elastic actuator comprising:
a linear driving mechanism comprising
a stepping motor;
a threaded rod assembly connected with the stepping motor; and
a linearly moveable member located at a side of the stepping motor and connected with and driven by the thread rod assembly to reciprocatively move along a power input axis;
an output member disposed on a side of the linearly moveable member and having a capability of linearly moving along a power output axis that is co-axial with the power input axis; and
an elastic member connected between the linearly moveable member and the output member to provide an elastic force along the power input axis.

2. The actuator as claimed in claim 1, wherein
the stepping motor has a rotator;
the output member is disposed between the linearly moveable member and the stepping motor and has a through hole;
the threaded rod assembly comprises
a threaded rod co-axially connected with the rotator and extending through the through hole in the output member along the power input axis; and
a sleeve mounted around the threaded rod and mounted in the linearly moveable member; and
the elastic member comprises a spring mounted around the threaded rod and having two ends abutting respectively on the linearly moveable member and the output member.

3. The actuator as claimed in claim 2 further comprising:
a rail being parallel with the threaded rod;
a bearing base disposed at a position distal from the stepping motor, wherein
the linearly moveable member and the output member are mounted on the rail; and
the threaded rod has an end distal from the stepping motor and mounted rotatably on the bearing base.

4. The actuator as claimed in claim 2 further comprising:
a rail being parallel with the threaded rod;
a supporting base disposed at a position distal from the stepping motor;
a supporting frame disposed at a position being adjacent to the stepping motor; and
a bearing base mounted in the supporting frame, wherein
the linearly moveable member and the output member are mounted on the rail; and
the threaded rod has two ends respectively mounted rotatably on the supporting base and the bearing base.

5. The actuator as claimed in claim 1, wherein
the stepping motor has a rotator having an axial hole defined through the rotator;
the output member further has
a movement space defined in the output member, and
a first side board and a second side board disposed respectively at two opposite sides of the movement space;
the through hole is defined through the first side board;
the threaded rod assembly comprises
a sleeve connected securely with one end of the rotator; and
a threaded rod linearly moveably mounted through the rotator, the sleeve, and the through hole in the first side board and extending into the movement space;
the linearly moveable member is linearly moveably mounted in the movement space and is connected with the threaded rod; and
the elastic member comprises a spring mounted around the threaded rod and having two ends abutting respectively on the linearly moveable member and the first side board.

6. The actuator as claimed in claim 5 further comprising a displacement sensor mounted on one side of the elastic member to detect a deformation of the elastic member and to calculate an output force.

7. The actuator as claimed in claim 4 further comprising a displacement sensor mounted on one side of the elastic member to detect a deformation of the elastic member and to calculate an output force.

8. The actuator as claimed in claim 3 further comprising a displacement sensor mounted on one side of the elastic member to detect a deformation of the elastic member and to calculate an output force.

9. The actuator as claimed in claim 2 further comprising a displacement sensor mounted on one side of the elastic member to detect a deformation of the elastic member and to calculate an output force.

10. The actuator as claimed in claim 1 further comprising a displacement sensor mounted on one side of the elastic member to detect a deformation of the elastic member and to calculate an output force.
